(19) United States
(12) Patent Application Publication
(10) Pub. No.: US 2022/0341254 A1
(43) Pub. Date: Oct. 27, 2022

(54) SUPPORT SYSTEM FOR TRANSPARENT DEVICES

(71) Applicant: SAGE ELECTROCHROMICS, INC., Faribault, MN (US)

(72) Inventors: Cody VanDerVeen, Faribault, MN (US); Jean-Christophe GIRON, Edina, MN (US); Alex S. COOPER, Waterville, MN (US); Alexandre RICHARD, Fribourg (CH)

(21) Appl. No.: 17/654,506

(22) Filed: Mar. 11, 2022

Related U.S. Application Data
(60) Provisional application No. 63/160,395, filed on Mar. 12, 2021.
(60) Provisional application No. 63/265,313, filed on Dec. 13, 2021.

(51) Int. Cl. E06B 9/24; G02F 1/153

(52) U.S. Cl. CPC E06B 9/24; G02F 1/1533; E06B 2009/2464

(57) ABSTRACT

A display framing system is disclosed. The display framing system can include a first pane and a framing system to support the first pane. The framing system can include a first side. The display framing system can also include a transparent electroactive device and a support system coupled to the transparent electroactive device and coupled to the first side of the framing system. The support system can include a body that is orthogonal to the first side of the framing system. In one embodiment, the first pane can include an electrochromic device.

### CROSS-REFERENCE TO RELATED APPLICATION(S)

This application claims priority under 35 U.S.C. § 119(e) to U.S. Provisional Application No. 63/160,395, entitled “SUPPORT SYSTEM FOR TRANSPARENT DEVICES,” by Cody VanDerVeen et al., filed Mar. 12, 2021, and to U.S. Provisional Application No. 63/265,313, entitled “SUPPORT SYSTEM FOR TRANSPARENT DEVICES,” by Alexandre Richard et al., filed Dec. 13, 2021, all of which are assigned to the current assignee hereof and incorporated by reference in their entireties.

### FIELD OF THE DISCLOSURE

The present disclosure is related to transparent devices and systems of supporting the same.

### BACKGROUND

An electrochemical device can include an electrochromic stack where transparent conductive layers are used to provide electrical connections for the operation of the stack. Electrochromic (EC) devices employ materials capable of reversibly altering their optical properties following electrochemical oxidation and reduction in response to an applied potential. Electrochromic devices alter the color, transmittance, absorbance, and reflectance of energy by inducing a change the electrochemical material. Specifically, the optical modulation is the result of the simultaneous insertion and extraction of electrons and charge compensating ions in the electrochemical material lattice.

Such devices can be within an insulated glazing unit that is supported by a framing system. The framing system can be a permanent installation that protects the electronics of the insulated glazing unit. Additionally, support systems for such devices need to maintain the integrity of not only the electrochromic device itself but also of the surrounding insulating space. Additional transparent devices may work in conjunction with insulated glazing units. Once such device is a transparent organic light emitting diode (TOLED) device. Traditionally, when such devices are in conjunction, the TOLED device is permanently installed as part of and within the insulated glazing unit. However, due to the shorter life span that the transparent device has, in order to repair or replace the transparent device, the entire unit—including the still functioning insulated glazing unit—would need to be removed and replaced.

As such, further improvements are sought in supporting transparent devices within a glass architecture.

### BRIEF DESCRIPTION OF THE DRAWINGS

FIG. 1 illustrates a planar view of a system that can include a transparent device and support system, according to one embodiment.

FIG. 2A illustrates a planar view of the support system of FIG. 1, according to one embodiment.

FIG. 2B is a schematic planar view of part of the support system of FIG. 2A, according to one embodiment.

FIG. 2C is a schematic side-view of the support system of FIG. 1, according to one embodiment.

FIG. 3A illustrates a planar view of the support system of FIG. 1, according to one embodiment.

FIG. 3B is a schematic side-view of the support system of FIG. 1, according to one embodiment.

FIG. 4A is a schematic bottom view of the support system in conjunction with a transparent device, according to one embodiment.

FIG. 4B is a schematic planar view of the support system in conjunction with a transparent device, according to one embodiment.

FIG. 5A is a schematic representation of the support system in conjunction with a transparent device, according to one embodiment.

FIG. 5B is a schematic representation of the support system in conjunction with a transparent device, according to one embodiment.

FIGS. 6A and 6B are a schematic planar and side-view, respectively of the support system used in conjunction with a framed glass system, according to one embodiment.

FIG. 7 is a schematic representation of the cover of the support system, according to one embodiment.

FIG. 8A is a schematic representation of the support system used in conjunction with a framed glass system, according to one embodiment.

FIG. 8B is a schematic representation of the support system used in conjunction with a framed glass system, according to another embodiment.

FIG. 9 illustrates a planar view of a system that can include a transparent device and support system, according to one embodiment.

FIG. 10 is a schematic side-view of an electrochromic device, according to one embodiment of the present disclosure.

FIG. 11 is a schematic illustration of an insulated glazing unit, according to the embodiment of the present disclosure.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific embodiments and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one, and the singular also includes the plural, or vice versa, unless it is clear that it is meant otherwise.

The use of the word “about,” “approximately,” or “substantially” is intended to mean that a value of a parameter is close to a stated value or position. However, minor differences may prevent the values or positions from being exactly as stated.

Patterned features, which include bus bars, holes, holes, etc., can have a width, a depth or a thickness, and a length, wherein the length is greater than the width and the depth or thickness. As used in this specification, a diameter is a width for a circle, and a minor axis is a width for an ellipse.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

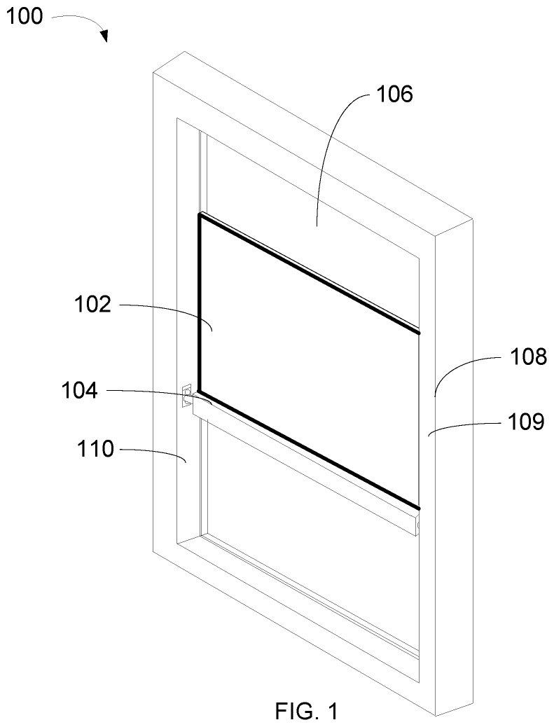

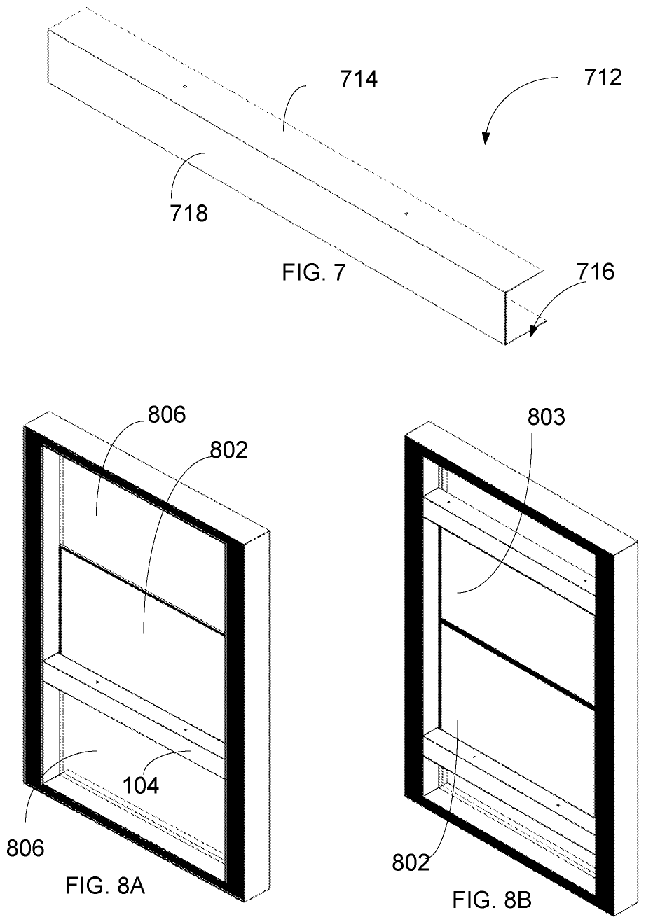

FIG. 1 illustrates a planar view of a system 100 that can include a transparent device 102 and support system 104, according to one embodiment. The system can include an electrochromic device within an insulated glazing unit (IGU) 106. The electrochromic device can be on a substrate and subsequently processed, as described below with respect to FIG. 7 and FIG. 8. In one embodiment, each of the electrochromic devices can be processed as a laminate such that the system 100 can include more than one laminate. In another embodiment, each of the electrochromic devices can be processed as an insulated glazing unit (IGU) such that the system 100 can include more than one insulated glazing unit (IGU), as described in more detail below with respect to FIG. 8. The framing system 108 that supports the one or more IGUs 106 can be a part of a building and already installed prior to the installation of the transparent device 102.

The transparent device 102 can be a transparent organic light emitting diode device. In another embodiment, the transparent device 102 can be a light emitting diode. In another embodiment, the transparent device 102 can be a liquid crystal display device. The transparent device 102 can be external to the IGU 106. In other words, the transparent device can be included to the system 100 after the IGU 106 has been installed.

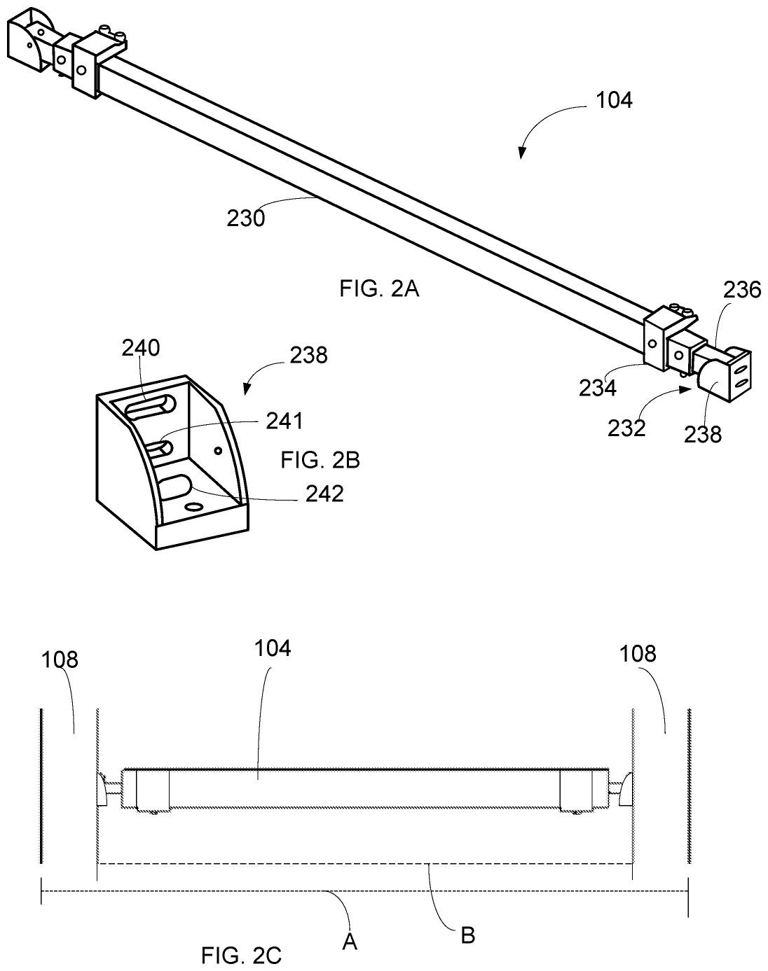

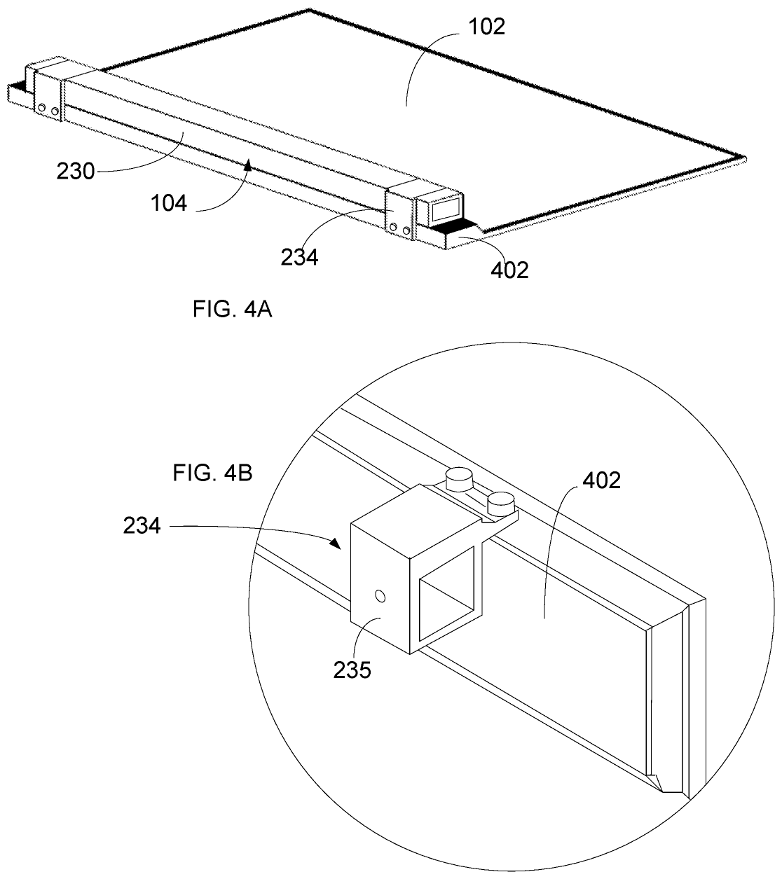

The support system 104 of the transparent device 102 can include a body 230, a first mount 232, and a second mount 234, as seen in FIG. 2A. The support system 104 can include a material selected from the group consisting of aluminum, steel, stainless steel, carbon steel, polyvinyl chloride, synthetic polymers, metal composites, or any combination thereof. In one embodiment, the first mount 232 can include a rod 236 and a plate 238. In one embodiment, the rod 236 can be attached to the plate 238 on a first end and attached to the body 230 on a second end. In one embodiment, the rod 236 can be a telescoping rod that goes into the body 230. In one embodiment, the plate 238, as seen in FIG. 2B, can include two adjustable slots, 240 and 241. The plate 238 can be installed first into the framing system of an electrochromic device. Bolts used within the slots 240, 241 can subsequently be used to adjust the support system 104 within the x-axis, or by adjusting the support system 104 horizontally and provide for an easier installation. The plate 238 can also include slot 242. The slot 242 can be orthogonal to slots 240, 241. The slot 242 can be used in conjunction with a screw or bolt to adjust the support system 104 vertically and provide for adjustment to ensure the entire support system 104 is level. In one embodiment, the second mount 234 can be used to secure the support system 104 to a transparent device, as seen in FIGS. 4A and 4B.

The plate 238 can contact a single surface of the framing system 108 without penetrating the IGU 108, maintaining the hermetic seal and integrity of the electroactive device. Since electrochemical devices contain electrochemical materials that are sensitive not only to environmental factors but also conductive elements, the active layers of electrochemical devices need to be sealed from the environment. By using a support system 104 that does not puncture or penetrate the active layers or sealed environment surrounding the active layers of the device, the active layers are protected from humidity and other contaminants.

The rod 236 can be an adjustable rod. The rod 236 can be a telescoping rod. In another embodiment, the rod 236 can be a spring rod. In one embodiment, a portion of the rod 236 can be located within the body 230. In another embodiment, the rod 236 can be located completely outside the body 230. The body 230 can include an opening in which the rod 236 can move in and out of. The rod 236 can be circular, square, rectangular, or other geometric shape. The plate 238 can be affixed or attached to the framing system 108 using screws, bolts, tension, suction, or adhesive. The body 230 of the support system 104 can be square, circular, rectangular, or other geometric shape. The body 230 can have a length that is between 75% and 99% of a length of the transparent device 102. In one embodiment, the body 230 can be adjustable to make the body longer or shorter. In another embodiment, both the body 230 and the rod 236 can be adjustable. The body 230 can be threaded with the rod 236. In one embodiment, the rod 236 can have a length that is less than the length of the body 230. In one embodiment, the rod 236 can include more than one portion attached to each end of the body 230. In one embodiment, the length of the transparent device 102 can be smaller than a length A of the framing system 108. In other words, the transparent device 102 and the support system 104 can fit within the framing system 108. In one embodiment, a total length B of the support system 104 can be adjusted. In one embodiment, the total length B of the support system 104 can be less than the length A of the framing system 108.

As seen in FIG. 2C, the body 230 of the support system 104 can be orthogonal to a side of the framing system 108 to which it is attached. In one embodiment, the framing system 108 can have a front face 109 that is parallel to the IGU 106 and faces an interior space, and an interior face 110 that is orthogonal to the IGU 106. In one embodiment, the body 230 is orthogonal to the interior face 110 of the framing system 108. The support system 104 can be between two interior facing sides of the framing system 108. The plate 238 can be attached to the interior facing surface 110 of the framing system 108.

The support system 104 can also include a second mount 234. The second mount 234 can be affixed to the body 230 of the support system 104. In one embodiment, the second mount 234 can include a plate. The plate can be of any geometric shape, including square, rectangle, triangular, parallelogram, or circular. In one embodiment, the second mount 234 can be affixed to the body 230 using screws, bolts, or other adhesive. In another embodiment, the second mount 234 can be machined as part of the body 230. In another embodiment, the second mount 234 can include a ring 235. The ring 235 can be circular, square, rectangular, hexagonal, or any other geometric shape. The ring 235 can be used to support the body 230, as seen in FIG. 4A. The ring 235 can include an opening that the body 230 fits into. As seen in FIGS. 4A and 4B, the second mount 234 can be used to affix the transparent device 102 to the support system 104. In one embodiment, the second mount 234 can be orthogonal to transparent device 102. In another embodiment, the second mount 234 is attached to the electronics component 402 of the transparent device 102. In one embodiment, the first mount 232 can be orthogonal to the second mount 234. In one embodiment, the first mount 232 can be attached to a first side of the body 230 and the second mount can be attached to a second side of the body 230, where the first side is orthogonal to the second side. In one embodiment, the first side can be parallel and face the interior facing surface 110 of the framing system 108. The support system 104, in one embodiment, can be removable from the framing system 108. In another embodiment, the support system 104 can include a hinge that provides for the transparent device 102 to pivot and expose the electrochromic device behind it.

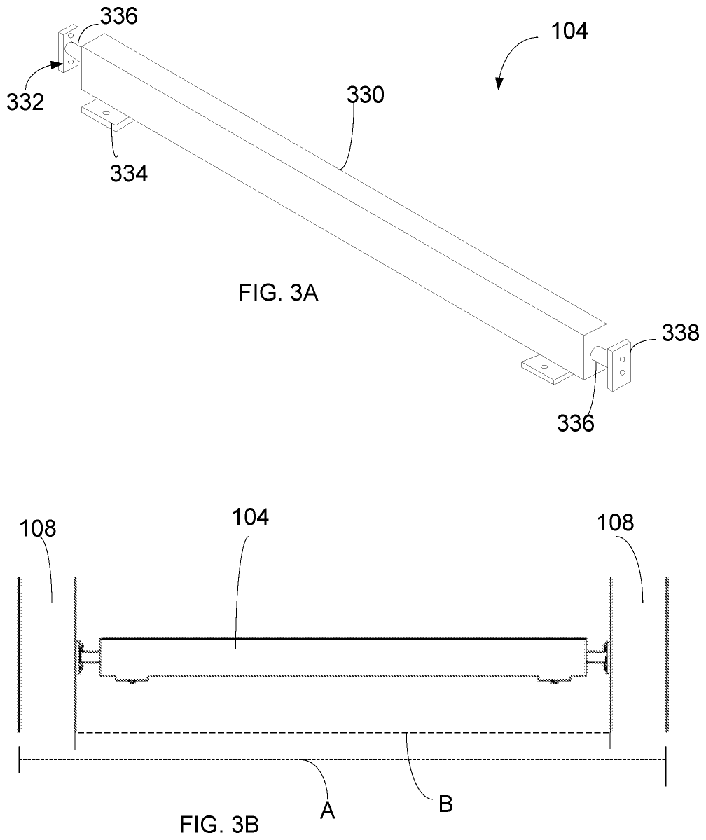

In another embodiment, the support system 104 of the transparent device 102 can include a body 330, a first mount 332, and a second mount 334, as seen in FIG. 3A. In one embodiment, the first mount 332 can include a rod 336 and a plate 338. In one embodiment, the rod 336 can be attached to the plate 338 on a first end and attached to the body 330 on a second end. The plate 338 can contact a single surface of the framing system 108 without penetrating the IGU 108, maintaining the hermetic seal and integrity of the electroactive device.

The rod 336 can be substantially similar to rod 236. In one embodiment, the rod 336 can be an adjustable rod. In another embodiment, the rod 336 can be a telescoping rod. In another embodiment, the rod 336 can be a spring rod. In one embodiment, a portion of the rod 336 can be located within the body 330. In another embodiment, the rod 336 can be located completely outside the body 330. The body 330 can include an opening in which the rod 336 can move in and out of. The plate 338 can be affixed or attached to the framing system 108 using screws, bolts, tension, suction, or adhesive. The body 330 of the support system 104 can be square, circular, rectangular, or other geometric shape. The body 330 can have a length that is between 75% and 99% of a length of the transparent device 102. In one embodiment, the body 330 can be adjustable to make the body longer or shorter. In another embodiment, both the body 330 and the rod 336 can be adjustable. The body 330 can be threaded with the rod 336. In one embodiment, the rod 336 can have a length that is less than the length of the body 330. In one embodiment, the rod 336 can include more than one portion, attached to each end of the body 330. In one embodiment, the length of the transparent device 102 can be smaller than a length A of the framing system 108. In other words, the transparent device 102 and the support system 104 can fit within the framing system 108. In one embodiment, a total length B of the support system 104 can be adjusted. In one embodiment, the total length B of the support system 104 can be less than the length A of the framing system 108.

As seen in FIG. 3B, the body 330 of the support system 104 can be orthogonal to a side of the framing system 108 to which it is attached. In one embodiment, the framing system 108 can have a front face 109 that is parallel to the IGU 106 and faces an interior space, and an interior face 110 that is orthogonal to the IGU 106. In one embodiment, the body 330 is orthogonal to the interior face 110 of the framing system 108. The support system 104 can be between two interior facing sides of the framing system 108. The plate 338 can be attached to the interior facing surface 110 of the framing system 108.

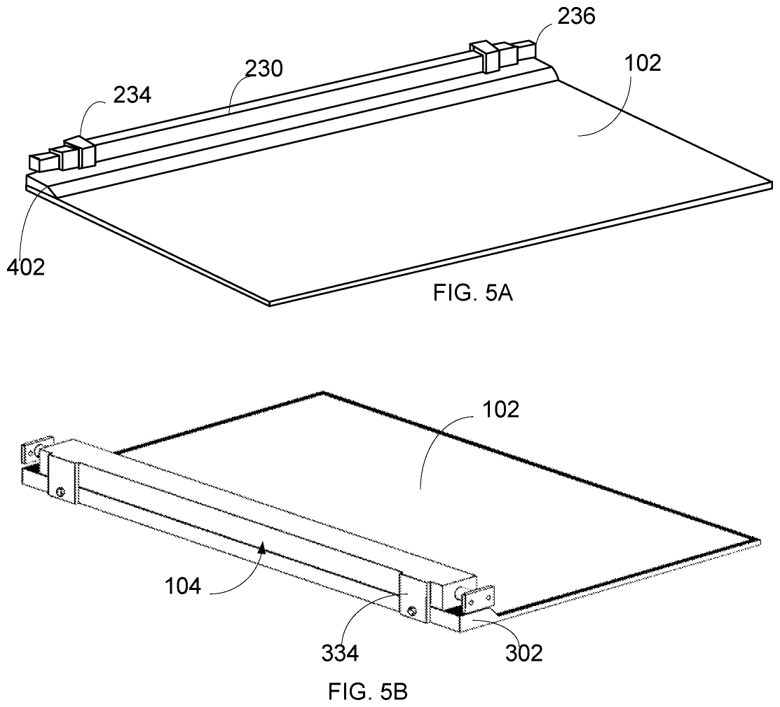

The support system 104, as seen in FIG. 3A, can also include a second mount 334. The second mount 334 can be affixed to the body 330 of the support system 104. In one embodiment, the second mount 334 can include a plate. The plate can be of any geometric shape, including square, rectangle, triangular, parallelogram, or circular. In one embodiment, the second mount 334 can be affixed to the body 330 using screws, bolts, or other adhesive. In another embodiment, the second mount 334 can be machined as part of the body 330. As seen in FIG. 5B, the second mount 334 can be used to affix the transparent device 102 to the support system 104. In one embodiment, the second mount 334 can be orthogonal to transparent device 102. In another embodiment, the second mount 334 is attached to the electronics component 302 of the transparent device 102. In one embodiment, the first mount 332 can be orthogonal to the second mount 334. In one embodiment, the first mount 332 can be attached to a first side of the body 330 and the second mount can be attached to a second side of the body 330, where the first side is orthogonal to the second side. In one embodiment, the first side can be parallel and face the interior facing surface 110 of the framing system 108.

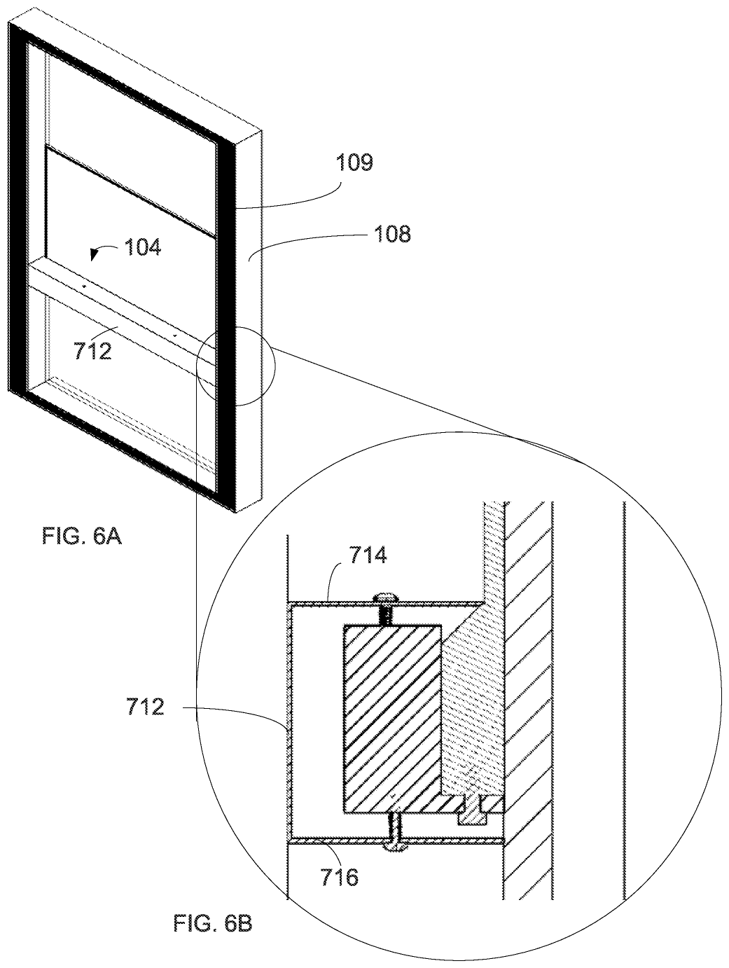

As seen in FIGS. 6A, 6B, and 7, the support system 104 can include a cover 712. In one embodiment, the cover 712 can match the framing system 108. The cover 712 can include three sides. In one embodiment, the cover can include a first side 714 opposite and parallel to a second side 716, and third side 718 orthogonal to and between the first side 714 and the second side 716. In one embodiment, the third side 718 faces an interior space. The third side 718 can be parallel to the front face 109 of the framing system 108. The cover 712 can cover and conceal the body 230, 330, first mount 232, 332, and second mount 234, 334 of the support system 104. In one embodiment, the first side 714 and the second side 716 are parallel to the second mount 234. In one embodiment, the cover 712 is attached to the body 230, 330 through the first side 714 and the second side 716. In one embodiment, the cover 714 can be affixed to the body 230, 330 using a screw, bolt, or pin.

As seen in FIGS. 8A and 8B, the support system 104 can go across the viewing area of the electrochromic device 806. Normally, limiting the viewing area of an electrochromic would be undesirable. However, by making the support system 104 adjustable, the display device 802 can be anywhere within the viewing area of the IGU, such as within the middle of the IGU 806. Additionally, the support system 104 for the transparent device 802 blends in with the framing system 108 of the IGU, such that when the transparent device 802 is not in use, an observer would not notice the combination. The transparent device 802 can have an electrochromic window above and below the device 802 while having a singular framing system. The removable transparent device 802 can be installed seamlessly after the IGU 806 is installed. As seen in FIG. 8B, more than one transparent device can be installed in a single IGU unit. A first transparent device 802 can abut a second transparent device 803. In one embodiment, a first and second support system can be on either end of the first transparent device 802 and the second transparent device 803. In other words, the first transparent device 802 can be the mirror-image of the second transparent device 803. In another embodiment, the first transparent device 802 can have the same orientation as the second transparent device 803. Advantageously, the support system 104 of the present disclosure is a non-penetrating system to the IGU but still supportive to a transparent device 102 and able to withstand from between 0.1 MPa to 30 MPa loads of force.

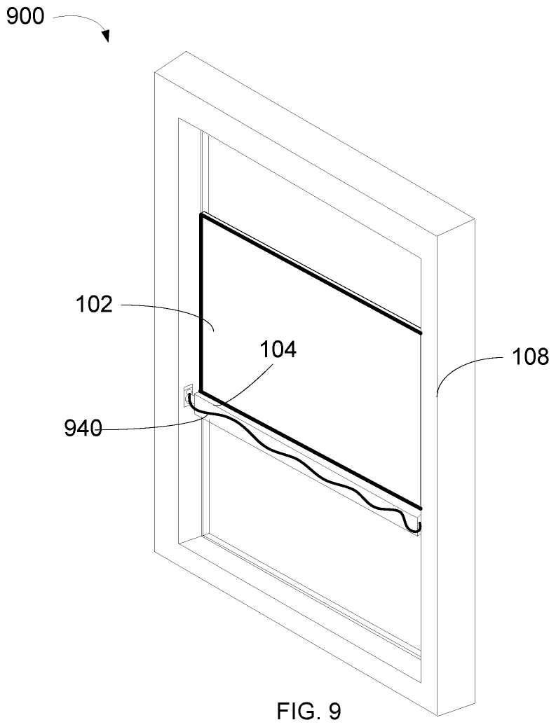

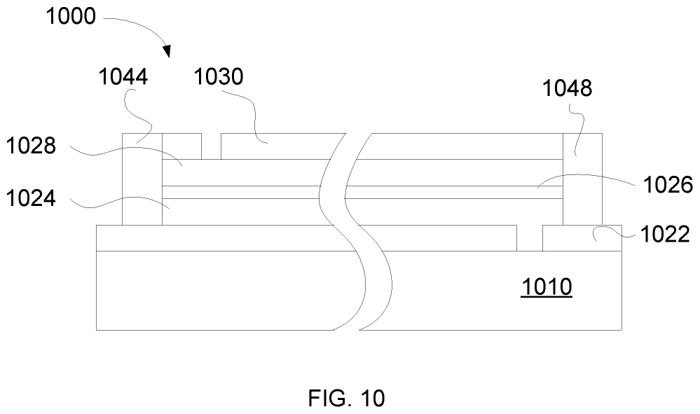

FIG. 9 illustrates a planar view of a system 900 that can include a transparent device 102 and support system, according to one embodiment. The system 900 can be similar to the system 100 of FIG. 1. As has been seen previously, the transparent device 102 can be installed utilizing the framing system 108 of the IGU after the IGU has been installed. The electronic wiring 940 of the transparent device 102 can run from the transparent device 102 to the frame 108 of the IGU. In one embodiment, as seen in FIG. 9, the wiring system 940 can run on the outside of the body 230, 330 of the support system 104. In one embodiment, the wiring system 940 can run along any surface of the body 230 of the support system 104. The wiring system 940 can then be hidden from view by the cover 712. In one embodiment, the wiring system 940 can run between the cover 712 and the body 230,330 of the support system 104. In one embodiment, the wiring system 940 can run along a portion of the body 230,330 of the support system 104. In another embodiment, the wiring system 940 can be within the body 230,330 of the support system 104. In one embodiment, the wiring system 940 can be threaded into and connected through the framing system 108.

In accordance with the present disclosure, FIG. 10 illustrates a cross-section view of a partially fabricated electroactive device 1000 having an improved film structure. For purposes of illustrative clarity, the electroactive device 1000 is a variable transmission device. In one embodiment, the electroactive device 1000 can be an electrochromic device. In another embodiment, the electroactive device 1000 can be a thin-film battery. In yet another embodiment, the electroactive device 1000 can be a liquid crystal device. In another embodiment, the electroactive device 1000 can be an organic light emitting diode device or light emitting diode device. In another embodiment, the electroactive device 1000 can be a dichroic device. However, it will be recognized that the present disclosure is similarly applicable to other types of scribed electroactive devices, electrochemical devices, as well as other electrochromic devices with different stacks or film structures (e.g., additional layers). The electroactive devices can be laminates or can be part of an insulated glazing unit, as described below.

With regard to the electrochemical device 1000 of FIG. 10, the device 1000 may include a substrate 1010 and a stack overlying the substrate 1010. The stack may include a first transparent conductor layer 1022, a cathodic electrochemical layer 1024, an anodic electrochemical layer 1028, and a second transparent conductor layer 1030. In one embodiment, the stack may also include an ion conducting layer 1026 between the cathodic electrochemical layer 1024 and the anodic electrochemical layer 1028.

In an embodiment, the substrate 1010 can include a glass substrate, a sapphire substrate, an aluminum oxynitride substrate, or a spinel substrate. In another embodiment, the substrate 1010 can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The substrate 1010 may or may not be flexible. In a particular embodiment, the substrate 1010 can be float glass or a borosilicate glass and have a thickness in a range of 0.5 mm to 12 mm thick. The substrate 1010 may have a thickness no greater than 16 mm, such as 12 mm, no greater than 10 mm, no greater than 8 mm, no greater than 6 mm, no greater than 5 mm, no greater than 3 mm, no greater than 2 mm, no greater than 1.5 mm, no greater than 1 mm, or no greater than 0.01 mm. In another particular embodiment, the substrate 1010 can include ultra-thin glass that is a mineral glass having a thickness in a range of 50 microns to 300 microns. In a particular embodiment, the substrate 1010 may be used for many different electrochemical devices being formed and may be referred to as a motherboard.

Transparent conductive layers 1022 and 1030 can include a conductive metal oxide or a conductive polymer. Examples can include a tin oxide or a zinc oxide, either of which can be doped with a trivalent element, such as Al, Ga, In, or the like, a fluorinated tin oxide, or a sulfonated polymer, such as polyaniline, polypyrrole, poly(3,4-ethylenedioxythiophene), or the like. In another embodiment, the transparent conductive layers 1022 and 1030 can include gold, silver, copper, nickel, aluminum, or any combination thereof. The transparent conductive layers 1022 and 1030 can include indium oxide, indium tin oxide, doped indium oxide, tin oxide, doped tin oxide, zinc oxide, doped zinc oxide, ruthenium oxide, doped ruthenium oxide, and any combination thereof. The transparent conductive layers 1022 and 1030 can have a thickness between 10 nm and 600 nm. In one embodiment, the transparent conductive layers 1022 and 1030 can have a thickness between 200 nm and 500 nm. In one embodiment, the transparent conductive layers 1022 and 1030 can have a thickness between 320 nm and 460 nm. In one embodiment, the first transparent conductive layer 1022 can have a thickness between 10 nm and 600 nm. In one embodiment, the second transparent conductive layer 1030 can have a thickness between 80 nm and 600 nm.

The layers 1024 and 1028 can be electrode layers, wherein one of the layers may be a cathodic electrochemical layer, and the other of the layers may be an anodic electrochromic layer (also referred to as a counter electrode layer). In one embodiment, the cathodic electrochemical layer 1024 is an electrochromic layer. The cathodic electrochemical layer 1024 can include an inorganic metal oxide material, such as WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), or any combination thereof and can have a thickness in a range of 40 nm to 600 nm. In one embodiment, the cathodic electrochemical layer 1024 can have a thickness between 100 nm to 400 nm. In one embodiment, the cathodic electrochemical layer 1024 can have a thickness between 350 nm to 390 nm. The cathodic electrochemical layer 1024 can include lithium, aluminum, zirconium, phosphorus, nitrogen, fluorine, chlorine, bromine, iodine, astatine, boron; a borate with or without lithium; a tantalum oxide with or without lithium; a lanthanide-based material with or without lithium; another lithium-based ceramic material; or any combination thereof. The anodic electrochromic layer 1028 can include any of the materials listed with respect to the cathodic electrochromic layer 1024 or Ta₂O₅, ZrO₂, HfO₂, Sb₂O₃, or any combination thereof, and may further include nickel oxide (NiO, Ni₂O₃, or combination of the two), and Li, Na, H, or another ion and have a thickness in a range of 40 nm to 500 nm. In one embodiment, the anodic electrochromic layer 1028 can have a thickness between 150 nm to 300 nm. In one embodiment, the anodic electrochromic layer 1028 can have a thickness between 250 nm to 290 nm. In some embodiments, lithium may be inserted into at least one of the first electrode 1030 or second electrode 1040.

In another embodiment, the device 1000 may include a plurality of layers between the substrate 1010 and the first transparent conductive layer 1022. In one embodiment, an antireflection layer can be between the substrate 810 and the first transparent conductive layer 1022. The antireflection layer can include SiO₂, NbO₂, Nb₂O₅ and can be a thickness between 20 nm to 100 nm. The device 1000 may include at least two bus bars with one bus bar 1044 electrically connected to the first transparent conductive layer 1022 and the second bus bar 1048 electrically connected to the second transparent conductive layer 1030.

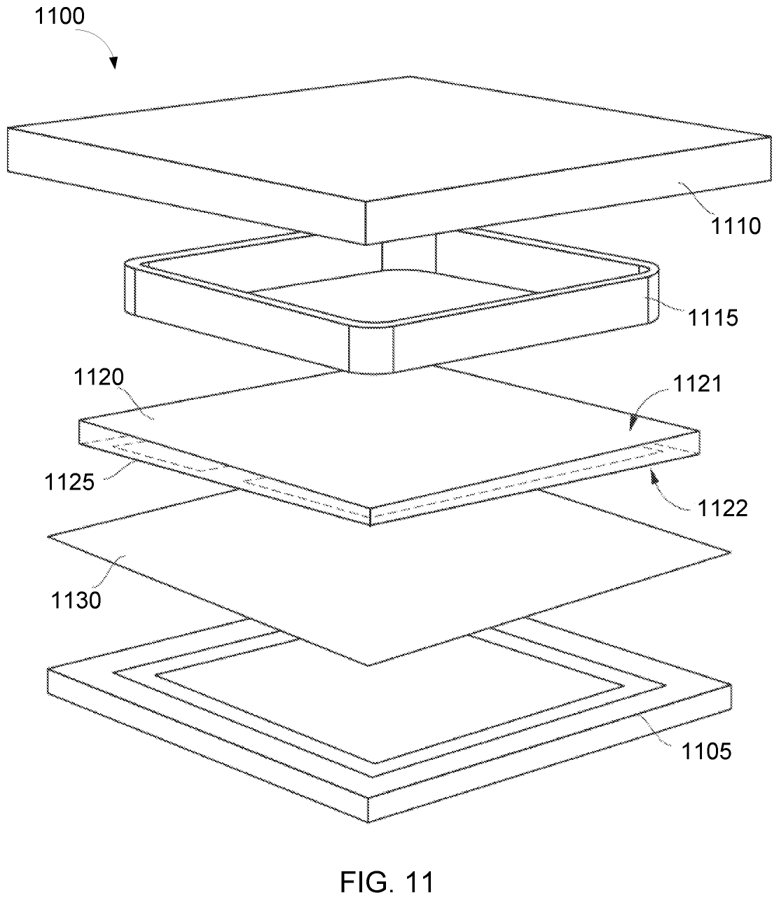

Any of the electrochromic devices can be subsequently processed as a part of an insulated glass unit or laminate device. FIG. 11 is a schematic illustration of an insulated glazing unit 1100 according to the embodiment of the current disclosure. The insulated glass unit 1100 can include a first panel 1105, an electrochemical device 1120 coupled to the first panel 1105, a second panel 1110, and a spacer 1115 between the first panel 1105 and second panel 1110. The first panel 1105 can be a glass panel, a sapphire panel, an aluminum oxynitride panel, or a spinel panel. In another embodiment, the first panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The first panel 1105 may or may not be flexible. In a particular embodiment, the first panel 1105 can be float glass or a borosilicate glass and have a thickness in a range of 2 mm to 20 mm thick. The first panel 1105 can be a heat-treated, heat-strengthened, or tempered panel. In one embodiment, the electrochemical device 1120 is coupled to the first panel 1105. In another embodiment, the electrochemical device 1120 is on a substrate 1125, and the substrate 1125 is coupled to the first panel 1105. In one embodiment, a lamination interlayer 1130 may be disposed between the first panel 1105 and the electrochemical device 1120. In one embodiment, the lamination interlayer 1130 may be disposed between the first panel 1105 and the substrate 1125 containing the electrochemical device 1120. The electrochemical device 1120 may be on a first side 1121 of the substrate 1125 and the lamination interlayer 1130 may be coupled to a second side 1122 of the substrate. The first side 1121 may be parallel to and opposite from the second side 1122.

The second panel 1110 can be a glass panel, a sapphire panel, an aluminum oxynitride panel, or a spinel panel. In another embodiment, the second panel can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The second panel may or may not be flexible. In a particular embodiment, the second panel 1110 can be float glass or a borosilicate glass and have a thickness in a range of 5 mm to 30 mm thick. The second panel 1110 can be a heat-treated, heat-strengthened, or tempered panel. In one embodiment, the spacer 1115 can be between the first panel 1105 and the second panel 1110. In another embodiment, the spacer 1115 is between the substrate 1125 and the second panel 1110. In yet another embodiment, the spacer 1115 is between the electrochemical device 1120 and the second panel 1110.

In another embodiment, the insulated glass unit 1100 can further include additional layers. The insulated glass unit 1100 can include the first panel, the electrochemical device 1120 coupled to the first panel 1105, the second panel 1110, the spacer 1115 between the first panel 1105 and second panel 1110, a third panel, and a second spacer between the first panel 1105 and the second panel 1110. In one embodiment, the electrochemical device may be on a substrate. The substrate may be coupled to the first panel using a lamination interlayer. A first spacer may be between the substrate and the third panel. In one embodiment, the substrate is coupled to the first panel on one side and spaced apart from the third panel on the other side. In other words, the first spacer may be between the electrochemical device and the third panel. A second spacer may be between the third panel and the second panel. In such an embodiment, the third panel is between the first spacer and second spacer. In other words, the third panel is coupled to the first spacer on a first side and coupled to the second spacer on a second side opposite the first side.

The embodiments described above and illustrated in the figures are not limited to rectangular shaped devices. Rather, the descriptions and figures are meant only to depict cross-sectional views of a device and are not meant to limit the shape of such a device in any manner. For example, the device may be formed in shapes other than rectangles (e.g., triangles, circles, arcuate structures, etc.). For further example, the device may be shaped three-dimensionally (e.g., convex, concave, etc.).

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

Embodiment 1. A display framing system including: a first pane; a framing system to support the first pane, where the framing system includes a first side; a transparent electroactive device; and a support system coupled to the transparent electroactive device and coupled to the first side of the framing system, where the support system includes a body and where the body is orthogonal to the first side of the framing system.

Embodiment 2. A display framing system including: an electrochromic device; an electrochromic framing system to support the electrochromic device; a transparent organic light emitting diode device; and a support system coupled to the transparent organic light emitting diode device and the electrochromic framing system, where the support system has a length that is adjustable.

Embodiment 3. A display framing system including: an electrochromic device; an electrochromic framing system to support the electrochromic device, where the framing system includes a first side and a second side opposite the first side; a transparent organic light emitting diode device; and a support system coupled to the transparent organic light emitting diode and the electrochromic framing system, where the support system is coupled to the first and second side of the framing system.

Embodiment 4. The display framing system of embodiment 1, where the transparent electroactive device is selected from the group consisting of light emitting diode, liquid crystal device, transparent organic light emitting diode device.

Embodiment 5. The display framing system of embodiment 1, where the first pane includes an electrochromic device.

Embodiment 6. The display framing system of any one of embodiments 2, 3, or 5, where the electrochromic device includes: a substrate; a first transparent conductive layer; a second transparent conductive layer between the substrate and the first transparent conductive layer; an electrochromic layer between the first transparent conductive layer and the second transparent conductive layer; and an anodic electrochemical layer between the first transparent conductive layer and the second transparent conductive layer.

Embodiment 7. The display framing system of any one of embodiments 1, 2, or 3, where the support system includes a body, a first mount, and a second mount.

Embodiment 8. The display framing system of embodiment 5, where the first mount is coupled to the framing system, and where the second mount is coupled to the transparent device.

Embodiment 9. The display framing system of embodiment 6, where the first mount is orthogonal to the second mount.

Embodiment 10. The display framing system of any one of embodiments 1, 2, or 3, where the support system is able to support between 1 and 100 pounds.

Embodiment 11. The display framing system of embodiment 5, where the body has a length that is between 75% and 99% of a length of the framing system.

Embodiment 12. The display framing system of any one of embodiments 1, 2, or 3, where the support system further includes a cover, where the cover includes a first side opposite to and parallel to a second side, and a third side connecting the first side and the second side, and where the first side and the second side are orthogonal to the transparent device.

Embodiment 13. The display framing system of any one of embodiments 1, 2, or 3, where the support system further includes a movable rod.

Embodiment 14. The display framing system of embodiment 11, where the movable rod is a telescoping rod.

Embodiment 15. The display framing system of any one of embodiments 1, 2, or 3, further including a second transparent device and a second support system.

Embodiment 16. The display framing system of embodiment 4, where the substrate includes glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

Embodiment 17. The display framing system of embodiment 4, where the electrochromic device further includes an ion conducting layer between the cathodic electrochemical layer and the anodic electrochemical layer.

Embodiment 18. The display framing system of embodiment 14, where the ion-conducting layer includes lithium, sodium, hydrogen, deuterium, potassium, calcium, barium, strontium, magnesium, oxidized lithium, Li2WO4, tungsten, nickel, lithium carbonate, lithium hydroxide, lithium peroxide, or any combination thereof.

Embodiment 19. The display framing system of embodiment 4, where the electrochromic layer includes WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

Embodiment 20. The display framing system of embodiment 4, where the first transparent conductive layer includes indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

Embodiment 21. The display framing system of embodiment 4, where the second transparent conductive layer includes indium oxide, indium tin oxide, doped indium oxide, tin oxide, doped tin oxide, zinc oxide, doped zinc oxide, ruthenium oxide, doped ruthenium oxide, and any combination thereof.

Embodiment 22. The display framing system of embodiment 4, where the anodic electrochemical layer includes an inorganic metal oxide electrochemically active material, such as WO₃, V₂O₅, MoO₃, Nb₂O₅, TiO₂, CuO, Ir₂O₃, Cr₂O₃, Co₂O₃, Mn₂O₃, Ta₂O₅, ZrO₂, HfO₂, Sb₂O₃, a lanthanide-based material with or without lithium, another lithium-based ceramic material, a nickel oxide (NiO, Ni₂O₃, or combination of the two), and Li, nitrogen, Na, H, or another ion, any halogen, or any combination thereof.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A display framing system comprising:
a first pane;
a framing system to support the first pane, wherein the framing system comprises a first side;
a transparent electroactive device; and
a support system coupled to the transparent electroactive device and coupled to the first side of the framing system, wherein the support system comprises a body and wherein the body is orthogonal to the first side of the framing system.

2. The display framing system of claim 1, wherein the transparent electroactive device is selected from the group consisting of light emitting diode, liquid crystal device, transparent organic light emitting diode device.

3. The display framing system of claim 1, wherein the first pane comprises an electrochromic device.

4. The display framing system of claim 1, wherein the electrochromic device comprises:
a substrate;
a first transparent conductive layer;
a second transparent conductive layer between the substrate and the first transparent conductive layer;
an electrochromic layer between the first transparent conductive layer and the second transparent conductive layer; and
an anodic electrochemical layer between the first transparent conductive layer and the second transparent conductive layer.

5. The display framing system of claim 4, wherein the substrate comprises glass, sapphire, aluminum oxynitride, spinel, polyacrylic compound, polyalkene, polycarbonate, polyester, polyether, polyethylene, polyimide, polysulfone, polysulfide, polyurethane, polyvinylacetate, another suitable transparent polymer, co-polymer of the foregoing, float glass, borosilicate glass, or any combination thereof.

6. The display framing system of claim 4, wherein the electrochromic device further comprises an ion conducting layer between the cathodic electrochemical layer and the anodic electrochemical layer.

7. The display framing system of claim 4, wherein the electrochromic layer comprises WO₃, V₂O₅, MoO₃, Nb₂O₅, TiO₂, CuO, Ni₂O₃, NiO, Ir₂O₃, Cr₂O₃, Co₂O₃, Mn₂O₃, mixed oxides (e.g., W—Mo oxide, W—V oxide), lithium, aluminum, zirconium, phosphorus, nitrogen, fluorine, chlorine, bromine, iodine, astatine, boron, a borate with or without lithium, a tantalum oxide with or without lithium, a lanthanide-based material with or without lithium, another lithium-based ceramic material, or any combination thereof.

8. The display framing system of claim 4, wherein the first transparent conductive layer comprises indium oxide, indium tin oxide, doped indium oxide, tin oxide, doped tin oxide, zinc oxide, doped zinc oxide, ruthenium oxide, doped ruthenium oxide, silver, gold, copper, aluminum, and any combination thereof.

9. The display framing system of claim 4, wherein the second transparent conductive layer comprises indium oxide, indium tin oxide, doped indium oxide, tin oxide, doped tin oxide, zinc oxide, doped zinc oxide, ruthenium oxide, doped ruthenium oxide and any combination thereof.

10. The display framing system of claim 1, wherein the support system comprises a body, a first mount, and a second mount.

11. The display framing system of claim 10, wherein the first mount is coupled to the framing system, and wherein the second mount is coupled to the transparent device.

12. The display framing system of claim 11, wherein the first mount is orthogonal to the second mount.

13. The display framing system of claim 1, wherein the support system is able to support between 1 and 100 pounds.

14. The display framing system of claim 10, wherein the body has a length that is between 75% and 99% of a length of the framing system.

15. The display framing system of claim 1, wherein the support system further comprises a cover, wherein the cover comprises a first side opposite to and parallel to a second side, and a third side connecting the first side and the second side, and wherein the first side and the second side are orthogonal to the transparent device.

16. The display framing system of claim 1, wherein the support system further comprises a movable rod.

17. A display framing system comprising:
an electrochromic device;
an electrochromic framing system to support the electrochromic device;
a transparent organic light emitting diode device; and
a support system coupled to the transparent organic light emitting diode device and the electrochromic framing system, wherein the support system has a length that is adjustable.

18. The display framing system of claim 17, further comprising a telescoping rod.

19. The display framing system of claim 17, further comprising a second transparent device and a second support system.

20. A display framing system comprising:
an electrochromic device;
an electrochromic framing system to support the electrochromic device, where the framing system comprises a first side and a second side opposite the first side;
a transparent organic light emitting diode device; and
a support system coupled to the transparent organic light emitting diode and the electrochromic framing system, wherein the support system is coupled to the first and second side of the framing system.
